(19) United States
(12) Patent Application Publication
(10) Pub. No.: US 2026/0245001 A1
(43) Pub. Date: Aug. 20, 2026

(54) Distributed Continuity Infrastructure for Capacity-Governed Resource Handling

(71) Applicant: Tysaiah Floyd Franklin, Peculair, MO (US)

(72) Inventor: Tysaiah Floyd Franklin, Peculair, MO (US)

(21) Appl. No.: 19/458,735

(22) Filed: Jan. 24, 2026

Related U.S. Application Data
(63) Continuation-in-part of application No. 19/353,559, filed on Oct. 8, 2025.

(51) Int. Cl. G06Q 10/0631

(52) U.S. Cl. CPC G06Q 10/0631

(57) ABSTRACT

A continuity infrastructure system is disclosed for maintaining physical resource handling under saturation, scarcity, or constrained deployment conditions. The system includes a physical resource handling substrate governed by logical capacity allocations and operated according to a finite set of predefined operational states. Incoming resources continue to be accepted during saturation by transitioning among operational states rather than rejecting intake. Multiple infrastructure units may coordinate handling actions to redistribute, defer, or equivalently satisfy handling obligations without centralized dispatch or market-based control. Reconciliation data is recorded to enable auditability of operational state transitions and coordinated handling actions. The disclosed architecture supports continuity of handling after finite issuance of infrastructure units while preserving autonomous execution at each unit.

### CROSS-REFERENCE TO RELATED APPLICATIONS

This application is a continuation-in-part of U.S. Nonprovisional patent application Ser. No. 19/353,559, filed Oct. 8, 2025, entitled “Forta Vault Sovereign Hybrid Infrastructure Harvest, Conversion, and Enforcement Platform,” the entirety of which is incorporated herein by reference.

### FIELD OF THE INVENTION

The present disclosure relates generally to distributed continuity infrastructure for physical resource handling and system-level capacity management. More particularly, the disclosure relates to systems and methods for capacity-governed storage, buffering, coordination, and continuity enforcement across distributed infrastructure units managing physical resources under saturation, scarcity, or constrained deployment conditions, wherein physical handling actions are governed by deterministic control logic implemented at the infrastructure level.

### BACKGROUND OF THE INVENTION

Conventional infrastructure systems for energy and other physical resources are constrained by rigid capacity limits, centralized dispatch models, and reliance on rejection or curtailment when saturation occurs. Such systems are typically designed around ownership-based allocation and lack deterministic mechanisms for maintaining continuity once nominal storage or handling thresholds are exceeded.

Existing grid balancing, storage orchestration, and load management approaches depend on centralized forecasting, market-based coordination, or discretionary intervention. These approaches do not address post-issuance scarcity conditions arising from finite infrastructure deployment, nor do they provide mechanisms for coordinated handling across independent infrastructure units without centralized control. Further, such systems do not provide machine-enforced operational state transitions governing physical intake, buffering, or release of resources at the infrastructure level.

### SUMMARY OF THE INVENTION

The disclosed continuation-in-part extends the Forta Vault infrastructure to provide continuity governance behaviors applicable to distributed infrastructure units operating under saturation, scarcity, or constrained deployment conditions. The system includes a physical resource handling substrate governed by logical capacity allocations that are adjustable independently of ownership of the resources being handled.

The infrastructure apparatus operates according to a finite set of predefined operational states that control acceptance, handling, coordination, and deferred execution of physical resources. Incoming resources continue to be accepted during saturation by transitioning among operational states rather than rejecting or curtailing intake.

In distributed configurations, multiple infrastructure units coordinate handling actions to redistribute, defer, or equivalently satisfy handling obligations using available capacity across units, without reliance on centralized dispatch, forecasting, or market-based control. Operational state transitions and coordinated handling actions are enforced deterministically according to predefined control rules executed by machine-level control systems and recorded for auditability and post-event reconciliation.

The disclosed architecture introduces a post-issuance scarcity state defining system behavior after a finite issuance limit of infrastructure units has been reached, wherein continuity of physical resource handling is preserved without requiring expansion of physical infrastructure. In this state, secondary utilization and coordinated handling behaviors enable continued system operation under constrained infrastructure conditions.

The disclosed architecture enables continuity of physical resource handling after finite issuance of infrastructure units while preserving autonomous execution at each unit and interoperability with present or future infrastructure systems.

### BRIEF DESCRIPTION OF THE DRAWINGS

No drawings are submitted with this application. The invention is fully described by the written specification.

### DETAILED DESCRIPTION OF THE INVENTION

In example implementations, a Forta Vault continuity infrastructure apparatus includes a physical resource handling substrate comprising one or more storage, conversion, buffering, or release components configured to physically receive, store, transform, or discharge resources.

A capacity governance module defines logical capacity allocations corresponding to portions of the substrate, wherein the logical capacity allocations may be adjusted independently of ownership of resources handled by the substrate.

An execution control module is implemented as a hardware-constrained controller coupled to the physical resource handling substrate, wherein state transitions directly govern physical intake, buffering, conversion, or release mechanisms at the apparatus level. The execution control module operates the Forta Vault apparatus according to a predefined and finite set of operational states.

The operational states include:
a normal continuity state;
a saturation handling state entered when capacity thresholds are approached or exceeded;
an overflow coordination state for coordinated handling actions among multiple Forta Vault units;
a deferred execution state for postponing execution or release while preserving continuity;
an emergency override state for prioritizing handling under emergency conditions; and
a post-issuance scarcity state activated upon exhaustion of a predefined issuance limit of Forta Vault units.

An intake interface continues acceptance of incoming resources by transitioning among operational states rather than rejecting resources, wherein physical intake mechanisms remain active and are governed by the execution control module.

A coordination interface exchanges operational coordination data with one or more other Forta Vault units to enable coordinated redistribution or deferred handling of resources.

Equivalence-based satisfaction of handling obligations may be determined based on predefined equivalence criteria, including resource type, quantity, temporal handling window, and system-defined substitution thresholds. Such equivalence determinations are enforced through coordination records exchanged between distributed infrastructure units and validated by deterministic control rules executed at each participating unit.

Coordinated handling may be performed without physical relocation of resources from an originating Forta Vault unit, including equivalence-based satisfaction of handling obligations across distributed units.

Multiple Forta Vault units may operate as a distributed system. Each unit retains autonomous operational control while exchanging coordination data with other units. The system operates without reliance on centralized dispatch authority, wherein each infrastructure unit independently enforces state transitions based on locally available data and predefined control rules while participating in distributed coordination.

Coordinated handling actions utilize available capacity across units to mitigate localized saturation or scarcity conditions without centralized dispatch or real-time market negotiation.

In some implementations, a post-issuance scarcity state is activated when a predefined issuance limit of Forta Vault units is exhausted. In this state, secondary utilization of logical capacity allocations may be enabled according to predefined control rules without transfer of ownership or governance authority, allowing continued continuity of handling under finite infrastructure conditions.

Owners of Forta Vault units may select operational configurations that constrain execution behavior while preserving continuity guarantees. Example configurations include continuity-restricted configurations and utilization-enabled configurations. Selection of an operational configuration modifies execution constraints without altering the underlying physical substrate or continuity logic.

An emergency override state may temporarily supersede logical capacity allocations to prioritize handling during emergency conditions. Override actions are recorded by a reconciliation module and may be reviewed after restoration of normal operating conditions.

Operational state transitions and coordinated handling actions are enforced deterministically according to predefined control rules executed by the execution control module. Reconciliation records provide auditable evidence of system behavior without reliance on discretionary human intervention.

For example, in an energy handling implementation, a first infrastructure unit operating at or above a saturation threshold may transition to an overflow coordination state and coordinate with a second infrastructure unit possessing available capacity. The second unit may accept an equivalent handling obligation based on predefined equivalence criteria while the first unit retains physical custody of the resource, thereby preserving continuity without rejecting intake or requiring centralized dispatch.

The Forta Vault continuity infrastructure interoperates with present or future infrastructure systems, including storage systems, conversion systems, and public-sector infrastructure, while retaining autonomous operational control. The disclosed architecture is extensible to additional resource types without modification to the core operational logic.

1. A continuity infrastructure apparatus comprising:
a physical resource handling substrate including at least one storage, conversion, buffering, or release component configured to physically receive, store, transform, or discharge a resource;
a capacity governance module configured to define logical capacity allocations corresponding to portions of the physical resource handling substrate, wherein the logical capacity allocations are adjustable independently of ownership of the resource;
an execution control module comprising a hardware-constrained controller coupled to the physical resource handling substrate and configured to operate the apparatus according to a predefined and finite set of operational states;
wherein the operational states include at least a normal continuity state, a saturation handling state, an overflow coordination state, a deferred execution state, an emergency override state, and a post-issuance scarcity state;
an intake interface configured to continue acceptance of incoming resources by transitioning between the operational states when a nominal capacity threshold is approached or exceeded, without rejecting intake;
a coordination interface configured to exchange operational coordination data with one or more other continuity infrastructure apparatuses;
a reconciliation module configured to record operational state transitions, coordinated handling actions, and deferred execution outcomes;
wherein the execution control module enforces physical intake, buffering, conversion, or release actions at the substrate based on the operational states;
wherein each continuity infrastructure apparatus independently enforces operational state transitions based on locally available data without reliance on centralized dispatch authority; and
wherein the apparatus maintains continuity of resource handling during saturation or scarcity conditions without requiring centralized dispatch or market-based control.

2. A method of operating a plurality of continuity infrastructure apparatuses to preserve continuity of physical resource handling, comprising:
establishing logical capacity allocations within each apparatus independently of ownership of resources;
detecting a saturation condition or a post-issuance scarcity condition at a first apparatus;
transitioning the first apparatus into a saturation handling state or a post-issuance scarcity state;
continuing acceptance of incoming resources at the first apparatus during the saturation condition;
coordinating handling of resources with at least a second apparatus based on available capacity;
determining equivalence-based satisfaction of handling obligations based on predefined criteria including at least resource type, quantity, and temporal handling constraints;
executing coordinated handling actions without requiring centralized dispatch or physical relocation of the resource; and
recording reconciliation information corresponding to operational state transitions and coordinated handling actions.

3. A continuity infrastructure system comprising:
a plurality of continuity infrastructure apparatuses according to claim 1;
wherein each apparatus operates autonomously using locally available data and predefined control rules;
wherein the plurality of apparatuses coordinate handling actions through exchange of operational coordination data;
and wherein continuity of resource handling is preserved across the plurality of apparatuses under saturation or scarcity conditions without centralized dispatch.

4. A non-transitory computer-readable medium storing instructions that, when executed by one or more processors associated with a continuity infrastructure apparatus, cause the apparatus to:
define and enforce logical capacity allocations corresponding to a physical resource handling substrate;
transition between predefined operational states in response to saturation or scarcity conditions;
continue acceptance of incoming resources during saturation conditions;
coordinate handling actions with one or more additional apparatuses; and
record reconciliation data corresponding to operational state transitions and coordinated handling actions.

5. The apparatus of claim 1, wherein coordinated handling among apparatuses is performed without requiring physical relocation of resources from an originating apparatus.

6. The apparatus of claim 1, wherein coordinated handling includes equivalence-based satisfaction of handling obligations determined based on predefined criteria including resource type, quantity, and temporal handling constraints.

7. The apparatus of claim 1, wherein the post-issuance scarcity state is activated upon exhaustion of a predefined issuance limit of continuity infrastructure apparatuses.

8. The apparatus of claim 7, wherein secondary utilization of logical capacity allocations is enabled only after activation of the post-issuance scarcity state.

9. The apparatus of claim 8, wherein secondary utilization comprises time-limited authorization of logical capacity allocations without transfer of ownership or governance authority.

10. The apparatus of claim 1, wherein the execution control module enforces deterministic operational state transitions according to predefined control rules.

11. The apparatus of claim 1, wherein an owner selects an operational configuration that constrains execution behavior while preserving continuity guarantees.

12. The apparatus of claim 11, wherein the operational configuration comprises at least a continuity-restricted configuration and a utilization-enabled configuration.

13. The apparatus of claim 1, wherein the emergency override state temporarily supersedes logical capacity allocations and records override actions in the reconciliation module.

14. The apparatus of claim 1, wherein logical capacity allocations are dynamically adjustable during saturation to preserve higher-priority continuity obligations.

15. The apparatus of claim 1, wherein continued acceptance of incoming resources mitigates curtailment during saturation conditions.

16. The apparatus of claim 1, wherein coordinated handling utilizes available capacity across multiple apparatuses to reduce localized scarcity effects.

17. The apparatus of claim 1, wherein continuity of handling is maintained independently of ownership of the resources.

18. The apparatus of claim 1, wherein the apparatus remains operable in the absence of external forecasting, optimization, or centralized control systems.

19. The apparatus of claim 1, wherein operational state transitions and coordinated handling actions are auditable through reconciliation records.

20. The system of claim 3, wherein coordinated handling actions are executed using equivalence-based satisfaction without requiring expansion of physical infrastructure.
